(19) United States
(12) Patent Application Publication
(10) Pub. No.: US 2007/0220531 A1
(43) Pub. Date: Sep. 20, 2007

(54) Method and system for shimming COM objects

(75) Inventor: David S. Korn, Sunnyvale, CA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: Microsoft Corporation, Redmond, WA (US)

(21) Appl. No.: 11/375,401

(22) Filed: Mar. 15, 2006

(51) Int. Cl. G06F 9/46

(52) U.S. Cl. 719/328

(57) ABSTRACT

An intermediate object layer can be used to shim the interfaces of an object so that a calling application can request services from the object without referencing the object. The intermediate object layer holds a reference to the object. The intermediate object layer also includes a method for releasing the reference to the object, to facilitate unloading or replacement of the object without having to shut down applications that have requested services from the object. The intermediate object layer can be used to shim multiple objects that have the same interfaces.

### CROSS-REFERENCE TO RELATED APPLICATIONS

None.

### STATEMENT REGARDING FEDERALLY SPONSORED RESEARCH OR DEVELOPMENT

None.

### BACKGROUND

In various conventional software applications and/or under various operating systems, uninstalling a component of a software application requires shutting down the entire application. For example, COM objects are software building blocks that can be integrated into many type of applications. The lifetime of a COM object is managed by reference counts, which indicate the number of applications that currently reference (or have a link to) the COM object. Conventionally, COM objects are not able to inform a host program that the COM object is ready for unloading or replacement. Thus, when an update or other replacement object becomes available for the COM object, all applications with a reference to the COM object must be identified and shut down to allow replacement.

### BRIEF SUMMARY

In an embodiment, a method is provided for creating and shimming an instance of an object. The method begins by receiving a request from an application for an instance of a first object having at least one interface. An instance of a second object having the at least one interface is created, with the instance of the second object being identified by a second reference. An instance of a first object having the at least one interface is then created by the instance of the second object, with the instance of the first object being identified by a first reference. The instance of the first object corresponds to the object requested by the application. The instance of the second object provides a layer between the application and the first object. The first reference is stored in the instance of the second object, while the second reference is stored by the application. Note that although the application requested an instance of the first object, the application instead receives a reference to an instance of the second object.

In another embodiment, a method for managing objects is provided. The method includes creating one or more instances of a second object having at least one interface. In such an embodiment, each instance of the second object creates an instance of the first object. The reference for each instance of the first object is stored in the corresponding instance of the second object. Each reference to an instance of the first object is then released, which allows the first object to be removed.

In still another embodiment, a method of managing objects is provided. The method includes creating an instance of a second object having at least one interface, the instance of the second object having a reference. The second object creates an instance of a first object that also has the at least one interface. The instance of the first object is shimmed by the instance of the second object. A reference to the instance of the first object is then released, and the first object is replaced with a third object, the third object also having the at least one interface. Finally, at least one interface of an instance of the third object is shimmed with the instance of the second object.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The present invention is described in detail below with reference to the attached drawings figures, wherein:

FIG. 1 is a block diagram illustrating details of a system in accordance with an embodiment of the invention.

FIGS. 2A and 2B are block diagrams illustrating host applications interacting with COM objects via the same SHIM object in accordance with an embodiment of the invention.

FIG. 3 is a flow chart illustrating a process in accordance with an embodiment of the invention.

FIG. 4 is another flow chart illustrating a process in accordance with an embodiment of the invention.

FIG. 5 is another flow chart illustrating a process in accordance with an embodiment of the invention.

FIG. 6 is a block diagram illustrating details of a system for instantiating SHIM objects in accordance with an embodiment of the invention.

### DETAILED DESCRIPTION

Overview

In various embodiments, the invention is directed to a method and system for managing COM objects by using SHIM objects. When an application requests an interface of a COM object, a corresponding SHIM object can be linked to the application instead. The corresponding SHIM object then references the COM object. The corresponding SHIM object has the same number and type of interfaces as the requested COM object. Additionally, the SHIM object includes functionality to allow a referenced COM object to be released.

Due to the presence of the SHIM object, the original application requesting the object interface does not hold a reference to the COM object. Instead, the original application holds a reference to the SHIM object, while the SHIM object references the COM object. Since the SHIM object also contains functionality for releasing a reference, the COM object can be removed and/or uninstalled by having the SHIM object release the reference to the COM object. The program referencing the SHIM object does not have to be stopped or shut down for the COM object to be replaced.

As noted above, a SHIM object corresponding to a COM object has the same number and type of interfaces as the COM object. In an embodiment, the SHIM object can simply act as a pass-through module. Requests from the application for services by the COM object are received by the SHIM object and passed to the COM object without modification. Similarly, communications from the COM object to the application can be passed through without modification. In another embodiment, a SHIM object can modify and/or replace one or more services that an application requests from a COM object. For example, upon receiving a request for one of the services of a COM object, the SHIM object could modify the request. Alternatively, the SHIM object could contain functionality to entirely replace one or more services of a COM object. In such an embodiment, the SHIM object would not need to communicate with the COM object to perform a requested service.

In order to facilitate description of the invention, various embodiments will be described for using SHIM objects with COM objects. The Component Object Model (COM) refers to the fundamental “object model” on which ActiveX Controls and Object linking and Embedding (OLE) are built. Often, COM objects are referred to in the context of Microsoft Developer Network (MSDN). COM includes any independent platform that distributes an object-orientated system for creating binary software components that can interact. COM allows an object to expose its functionality to other components and to host applications. Additionally, COM defines both how the object exposes its interfaces and how this exposure works across processes and networks. Furthermore, COM defines the life cycle of an object. Although the examples described here refer to COM objects, SHIM objects could be implemented in other operating environments in order to provide a thin object layer between an application and an object referenced by the application to provide a service.

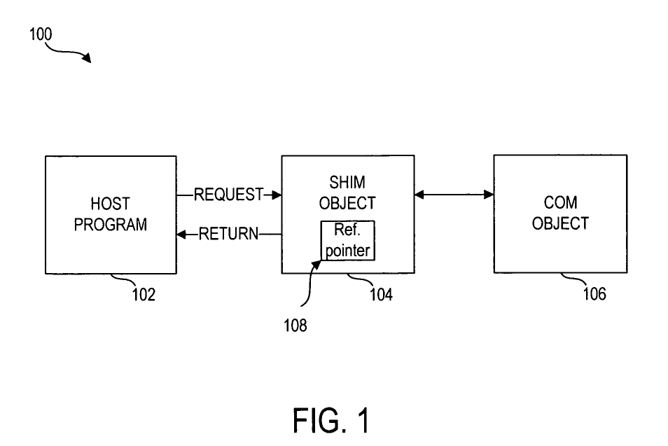

FIG. 1 shows an exemplary system 100 according to an embodiment of the invention. FIG. 1 illustrates a host program or application 102 communicating with an instance of a COM object 106 via an instance of a SHIM object 104. As shown in FIG. 1, the host program or application 102 indirectly communicates with the the COM object 106. When the host program 102 requests an interface of the COM object 106, the SHIM object 104 intercepts or receives the request instead. The SHIM object 104 can pass the request to the COM object 106 as is, or the SHIM object can modify the request before passing it to the COM object. After the COM object 106 performs a requested service, the SHIM object 104 can return the output to the host program 102, or the SHIM object can modify the output before returning it to the host program. The SHIM object 104 has a portion for keeping track of the COM object such as a reference pointer 108 corresponding to the COM object 104.

Examples of Shimming a COM Object

Conventionally, a COM object exposes its interfaces (e.g. set of procedural routines or services) directly to a host program or application that has referenced the COM object. When the host program desires a service from the COM object, a request is sent to the appropriate interface of the COM object. The COM object performs one or more actions based on the request, and can then return the results of the actions to the host program.

A SHIM object is an object that acts a layer between a host program and a COM object. The SHIM object isolates the COM object from the host program while exposing the same interfaces. For example, if a COM object has 3 interfaces, then the corresponding SHIM object will expose the same 3 interfaces. This isolation of a first (COM) object from the host program by a second (SHIM) object that exposes the same interfaces is defined as “shimming” the interfaces of the first object.

In an embodiment, when a SHIM object is interposed between a host program and a COM object, the host program will have a reference only to the SHIM object. In such an embodiment, the SHIM object will have a reference to the COM object. For example, when the host program attempts to reference the COM object, the host program will instead receive the globally unique identifier (GUID) for the SHIM object. Preferably, the GUID is a unique identifier for an object, such as a 128-bit integer. This allows a reference to an object to be easily stored. In such an embodiment, the GUID for the COM object can be stored in a known location for the SHIM object to reference it.

In an embodiment, a COM object (and its corresponding SHIM object) can have multiple interfaces, or services. For example, a COM object named “DOG” can have the interfaces IMakeSound and IMove. In an embodiment, the interface IMakeSound can have one service or method of Speak( ) and the interface IMove can have two methods or services called Run( ) and Walk( ). In such an embodiment, a host program, Owner, can create an instance of DOG and call methods on the two interfaces that DOG implements. This allows Owner to request that DOG perform one or more of the services Run( ), Walk( ), or Speak( ).

The SHIM object exposes the same interfaces to the host program as the COM object. In an embodiment, the SHIM object does not need to know anything about the internal implementation of the services provided by the COM object. As a result, the same SHIM object can be used to shim other objects that expose the same interfaces. For example, another COM object “CAT” having the same interfaces as DOG could be shimmed by the same SHIM object. In such an embodiment, the implementation of Speak( ), Walk( ), and Run( ) can be completely different within the objects CAT and DOG. However, because the interfaces exposed by DOG and CAT are the same, the same SHIM object can be used to shim either DOG or CAT.

In an embodiment, the SHIM object can act as a pass-through layer. In such an embodiment, the SHIM object does not modify communications between the host program and the COM object. When the SHIM object receives a request intended for one of the COM interfaces, the SHIM object passes the request to the corresponding interface. Similarly, any communication from the COM object to the host program is passed through without modification.

In another embodiment, the COM object can modify a request from the host program for a service provided by the COM object. For example, a host program could request that a COM object called DOG perform the action Speak( ). If passed directly to the DOG object, this would cause the DOG object to reply with a single sound, such as a bark. Upon receiving this request, however, the SHIM object could modify the request so that DOG receives a request to bark once, wait ten seconds, and bark again. The SHIM object would then return any output communication based on these actions from the DOG object to the host program. More generally, the SHIM object can pre-process or modify a request for a host program, and/or post-process or modify the response from a COM object.

In still another embodiment, the SHIM object could entirely replace the service provided by the COM object. Continuing with the DOG object example, when the host program requests the action Speak( ), the SHIM object could include separate functionality for performing this action. In such an embodiment, the request to Speak( ) would not be passed on to the DOG object. Instead, the SHIM object would provide its own action.

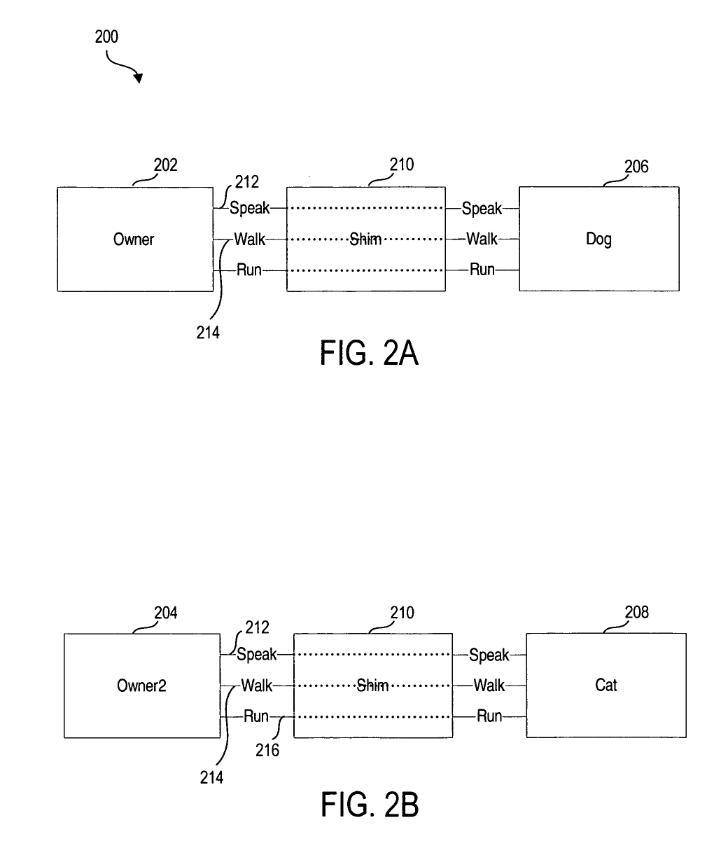

FIGS. 2A and 2B show an exemplary system 200 according to an embodiment of the invention. FIGS. 2A and 2B illustrate host applications Owner 202 and Owner2 204 communicating with instances of COM objects DOG 206 and CAT 208. As shown in FIGS. 2A and 2B, the host applications 202 and 204 indirectly communicate with the instances of COM objects 206 and 208 via the instance of the SHIM object 210. The DOG and CAT COM objects each have interfaces Speak( ) 212, Walk( ) 214, and Run( ) 216. Each of these interfaces is exposed via the SHIM object 210 to the applications 202 and 204, respectively. Note that the services provided by the Speak( ), Walk( ), and Run( ) interfaces can each be different for the objects DOG 206 and CAT 208. Because the same interfaces are exposed, however, a single type of SHIM object 210 can be used to shim the interfaces of both objects.

Method for Shimming a COM Object

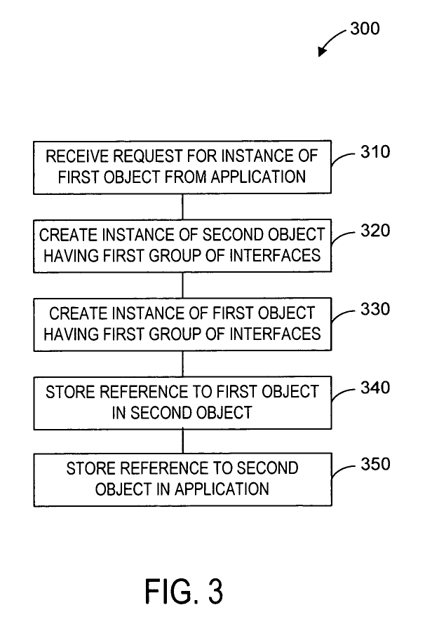

FIG. 3 depicts a process flow 300 for creating a SHIM object layer between a requesting application and a COM object according to an embodiment of the invention. Note that although the embodiment shown in FIG. 3 depicts a linear procedure flow, other sequences can be used for performing the procedures. In the embodiment shown in FIG. 3, a request is received 310 from an application for a service provided by a first object, such as a COM object. This desired COM object has a first group of interfaces. Based on this request, an instance of a second object is created 320. The second object has the same group of interfaces as the desired COM object. This second object will serve as a SHIM object layer between the application and the COM object. An instance of the desired COM object having the first group of interfaces is then created 330. Preferably, the instance of the desired COM object is created by the second object. When the instances of the first and second objects are created, references to the instances of the objects are also created. The reference to the instance of the first object is stored 340 in the instance of the second object. The reference to the instance of the second object is stored 350 in the application that initially requested the service provided by the COM object.

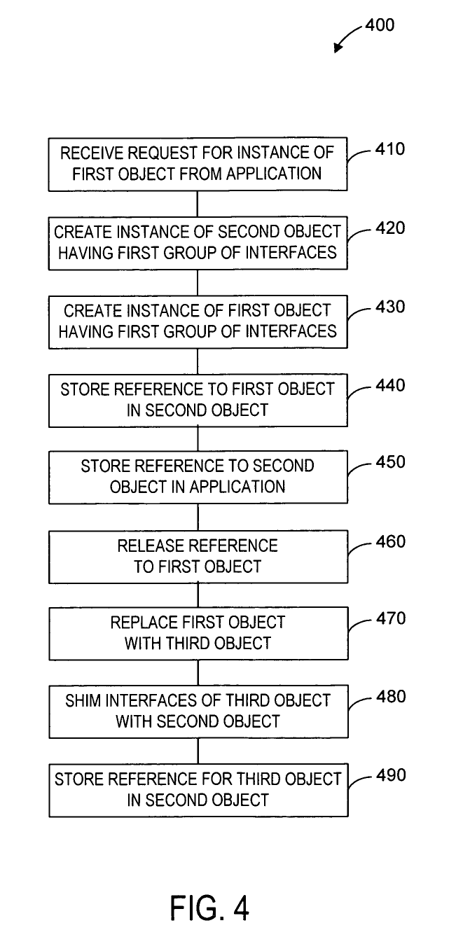

FIG. 4 depicts another process flow 400 for creating a SHIM object layer between a requesting application and a COM object according to an embodiment of the invention. Note that although the embodiment shown in FIG. 4 depicts a linear procedure flow, other sequences can be used for performing the procedures. In the embodiment shown in FIG. 4, a request is received 410 from an application for a service provided by a first object, such as a COM object. This desired COM object has a first group of interfaces. Based on this request, an instance of a second object is created 420. The second object has the same group of interfaces as the desired COM object. This second object will serve as a SHIM object layer between the application and the COM object. An instance of the desired COM object having the first group of interfaces is then created 430. Preferably, the instance of the desired COM object is created by the second object. When the instances of the first and second objects are created, references to the instances of the objects are also created. The reference to the instance of the first object is stored 440 in the instance of the second object. The reference to the instance of the second object is stored 450 in the application that initially requested the service provided by the COM object. The stored reference to the instance of the first object can subsequently be released 460, such as by having the instance of the second object perform a Release method. After the reference to the instance of the first object is released, the first object can be replaced 470 by a third object. The instance of the second object can then be used to shim 480 the interfaces of an instance of the third object. Preferably, a reference to the third object is also stored 490 in the instance of the second object.

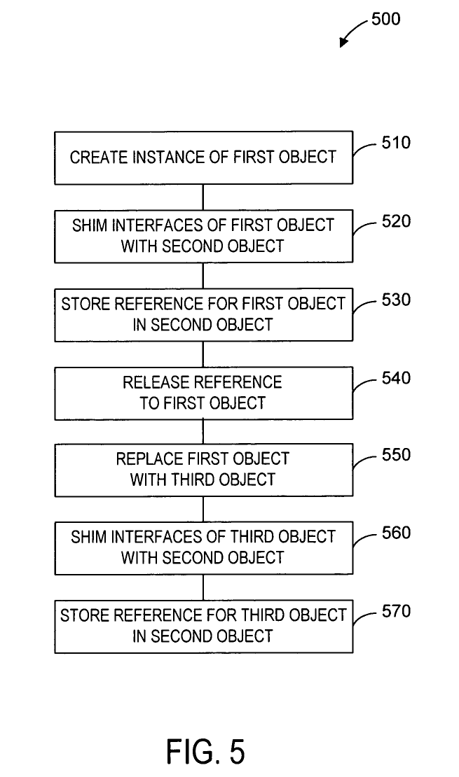

FIG. 5 depicts a process flow 500 for shimming the interfaces of an object according to an embodiment of the invention. Note that although the embodiment shown in FIG. 5 depicts a linear procedure flow, other sequences can be used for performing the procedures. In the embodiment shown in FIG. 5, an instance of a first object is created 510. In an embodiment, the instance of the first object can be created 510 by an application requesting the first object. In an alternative preferred embodiment, the instance of the first object can be created 510 by an instance of a second object. In such an embodiment, the second object can be an object created in response to a request by an application for an instance of the first object. The interfaces of the first object are then shimmed 520 with an instance of a second object. A reference to the instance of the first object is also stored 530 in the instance of the second object. The stored reference to the instance of the first object can subsequently be released 540, such as by having the instance of the second object perform a Release method. After the reference to the instance of the first object is released, the first object can be replaced 550 by a third object. The instance of the second object can then be used to shim 560 the interfaces of an instance of the third object. Preferably, a reference to the third object is also stored 570 in the instance of the second object.

Creation of SHIM and COM Objects

Conventionally, an operating system infrastructure may create a COM object using the following steps: retrieving the implementation file based on the GUID for the requested COM object in a registry; loading the retrieved implementation file; finding the Exported routine used to create objects, such as the Windows routine DllGetClassObject, and passing the object to the Exported routine; calling the Exported routine to retrieve the Factory Object that corresponds to the object; and requesting the Exported routine to create an instance of the object upon the determination of a valid Class Factory, such as by using the Windows method call CoCreateInstance.

In an embodiment, the invention provides a system for instantiating SHIM objects when a host program requests an instance of a COM object. The system includes a class factory for creating a SHIM object; and a linking module for mapping the SHIM object to a COM object. In such an embodiment, the linking module searches the registry for a SHIM object when a COM object is instantiated.

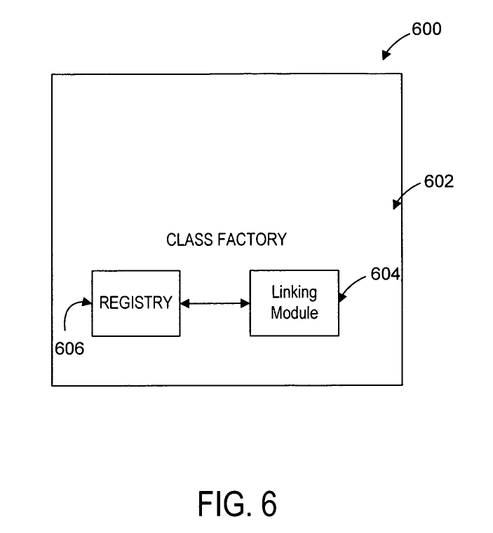

FIG. 6 shows an exemplary embodiment 600 of the class factory. As shown in FIG. 6 the class factory 602 creates SHIM objects. The linking module 604 interacts with the Registry 606 to map the SHIM object with a COM object. The linking module 604 uses the Registry 606 to map the GUID to the implementation file for the SHIM object.

Preferably, the implementation file can expose more than one type of object. In an embodiment, a different type of class factory is supplied for each object that is requested. In another embodiment, a single class factory is sufficient for all types of objects.

In an embodiment, the invention provides a SHIM object that can be used to shim the interfaces of any COM objects that have the same type and number of exposed interfaces. In this embodiment, more than one implementation file can correspond to a single SHIM object. If any of the implementation files corresponding to SHIM object are called, the same SHIM object will be returned that corresponds to the COM object. In this embodiment, the returning of the same SHIM object is achieved by writing a custom class factory for the SHIM object. For example, if the interfaces of an object of type X are to be shimmed, a host application will request the COM OS infrastructure to create an object of type X. The registry will then reply that the SHIM DLL implements that type of object. In response, the SHIM DLL is loaded, and the class factory for the SHIM DLL is requested to create an object of type X. The class factory receives the request for the object of type X and instead returns an object of type Y (e.g. the SHIM object). Preferably, the object of type Y (e.g. the SHIM Object) implements all the interfaces of an object of type X. In such an embodiment, the caller is unaware that it is communicating with an object of type Y.

In another embodiment, the SHIM object acts as a custom implementation for a set of interfaces that layers on top of a COM object. The SHIM object can shim the interfaces of any COM object that the OS requests. The SHIM object is aware of the real COM object via the registry. The registry provides a custom registration for storing information to keep track of the COM object. The registry holds a mapping between the GUID and the implementation file. In order for a SHIM object to shim a COM object, a sub-key needs to exist. This sub-key is the GUID of the real COM object. For example, the caller requests object X. The caller knows that it has to load object X because object X's GUID is stored in a location that is used by the caller. If object X is shimmed, the GUID of object X is replaced with the GUID of the SHIM object. As a result, when the caller requests object X, the SHIM object (e.g. object Y) is returned. Object Y has a new sub-key that contains the GUID of object X. The SHIM objects uses the standard COM Creation Mechanism (CoCreateInterface) to create the real object X and holds a reference to it.

Loading of COM Objects being Shimmed

In an embodiment, the SHIM object can load the COM object being shimmed based on an extra registry key. Preferably, each shimmed COM object has a unique key. The unique key informs the SHIM object of the GUID that corresponds to the COM object. In such an embodiment, the SHIM object creates the COM object in the same way any other application would create an instance of the COM object. The SHIM object creates a COM object by using the CoCreateInstance( ) API call, passing the GUID read from the registry and asking for the IUnknown Interface. The SHIM object can then query the IUnknown Interface for any of the interfaces being shimmed for the specified COM object.

Unloading of COM Objects being Shimmed

In another embodiment, the SHIM object can perform an operation to load or unload a COM object when the SHIM object determines that it is an appropriate time. In this embodiment, the SHIM object decrements the reference count by calling the method, Release( ). If the last instance of the COM object is released, the object exits the system. In response, the SHIM object calls the method, CoFreeUnusedLibraries( ), to ensure the Dynamic Link Library (DLL) that the COM object is implemented in can be unloaded. In such an embodiment, the COM System keeps the module in memory and this signals to the COM system to unload modules that are no longer needed in memory (i.e. those that have no objects reference counted).

In this embodiment, the SHIM object can be unloaded at specified times by the application. In another embodiment, the COM object being shimmed can be unloaded at any anytime by the SHIM object. One example of when the COM object is unloaded is during an uninstall. In this embodiment, a COM object may be unloaded without shutting down or rebooting the application.

The invention is described in the general context of computer-executable instructions, such as program modules, being executed by a computer. Generally, program modules include routines, programs, objects, components, data structures, etc. that perform particular tasks or implement particular abstract data types. Moreover, those skilled in the art will appreciate that the invention may be practiced with other computer system configurations, including hand-held devices, multiprocessor systems, microcontroller-based, microprocessor-based, or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote computer storage media including memory storage devices.

The invention claimed is:

1. A method for creating an instance of an object, comprising:
receiving a request from an application for an instance of a first object having at least one interface;
creating an instance of a second object having the at least one interface, the instance of the second object being identified by a second reference;
creating an instance of a first object having the at least one interface, the instance of the first object being identified by a first reference;
storing the first reference in the instance of the second object;
storing the second reference in the application.

2. The method of claim 1, wherein the first object is a COM object.

3. The method of claim 1, wherein the first reference is a globally unique identifier.

4. The method of claim 1, further comprising releasing the reference to the instance of the first object, and removing the first object.

5. The method of claim 1, further comprising releasing the reference to the instance of the first object, and replacing the first object with a third object having the at least one interface.

6. A method for managing objects, comprising:
creating one or more instances of a first object, the first object having at least one interface and each instance of the first object having a reference;
shimming the at least one interface of the one or more instances of a first object, each at least one interface being shimmed by a corresponding instance of a second object;
storing the reference for each instance of the first object in the corresponding instance of the second object;
releasing each reference to an instance of the first object; and
removing the first object.

7. The method of claim 6, wherein shimming the at least one interface comprises enabling bi-directional communication between an instance of the first object and an application.

8. The method of claim 6, wherein shimming the at least one interface comprises:
receiving, by the instance of the second object, a request for a service from an interface of the instance of the first object;
modifying the received request;
passing the modified request to the instance of the first object.

9. The method of claim 6, wherein shimming the at least one interface comprises:
receiving, at the instance of the second object, a request for a service from an interface of the instance of the first object;
performing the requested service to generate an output; and
sending the generated output in response to the received request.

10. The method of claim 6, wherein shimming the at least one interface comprises:
forwarding, to the instance of the first object, a request for a service;
receiving a reply from the instance of the first object;
modifying the received reply;
sending the modified reply in response to the request for the service.

11. The method of claim 6, further comprising:
receiving a third object having the at least one interface;
shimming the at least one interface of an instance of the third object by a corresponding instance of the second object.

12. The method of claim 11, wherein the first object is a COM object.

13. The method of claim 11, wherein the first object and the third object are different COM objects.

14. A method of managing objects, comprising:
creating an instance of a first object having at least one interface, the first object having a first reference;
shimming the at least one interface of the instance of the first object with an instance of a second object;
releasing the first reference to the instance of the first object;
replacing the first object with a third object, the third object having the at least one interface;
shimming the at least one interface of an instance of the third object with the instance of the second object.

15. The method of claim 14, wherein shimming the at least one interface of the instance of the first object comprises enabling bi-directional communication between the instance of the first object and an application.

16. The method of claim 14, wherein shimming the at least one interface of the instance of the third object comprises enabling bi-directional communication between the instance of the third object and an application.

17. The method of claim 14, wherein shimming the at least one interface of the instance of the first object comprises:
receiving, at the instance of the second object, a request for a service from an interface of the instance of the first object;
modifying the received request;
passing the modified request to the instance of the first object.

18. The method of claim 14, wherein shimming the at least one interface comprises:
receiving, at the instance of the second object, a request for a service from an interface of the instance of the first object;
performing the requested service to generate an output; and
sending the generated output in response to the received request.

19. The method of claim 14, wherein shimming the at least one interface comprises:
forwarding, to the instance of the first object, a request for a service;
receiving a reply from the instance of the first object;
modifying the received reply;
sending the modified reply in response to the request for the service.

20. The method of claim 14, wherein the first object is a COM object.
